(19) United States
(12) Patent Application Publication
(10) Pub. No.: US 2013/0014373 A1
(43) Pub. Date: Jan. 17, 2013

(54) Taxidermy Method

(71) Applicant: Coyt Jordan, Panama City, FL (US)

(72) Inventor: Coyt Jordan, Panama City, FL (US)

(21) Appl. No.: 13/544,963

(22) Filed: Jul. 9, 2012

Related U.S. Application Data
(60) Provisional application No. 61/572,045, filed on Jul. 11, 2011.

(51) Int. Cl. B29C 39/00; B23P 17/00

(52) U.S. Cl. 29/428; 264/222

(57) ABSTRACT

A taxidermy method as claimed includes removing horns from a skull of a horned animal, boiling the skull to remove organic matter from the skull, removing dual portions of the skull from behind the respective eye sockets of the skull to form cut-out regions, tooling a mold using the boiled skull with cut-out regions as a positive die, and making a replica of the skull with cut-out regions in the mold.

### CROSS REFERENCE TO RELATED APPLICATIONS

This application claims the benefit of provisional patent application Ser. No. 61/572,045 filed on 11 Jul. 2011 by the present inventor, which is incorporated by reference.

### BACKGROUND OF THE INVENTION

1. Field of the Invention

The present invention relates to the field of taxidermy and more particularly to the mounting of animal horns or antlers.

2. Description of the Prior Art

The general mounting for display of the head and antlers or just the antlers of horned animals onto a plaque (or other portable flat surface) is well known in taxidermy art. The use of kits for individuals to make their own mounts of the head and antlers or just the antlers of horned animals is also well known. The words “antler” and “antlers” are used throughout this document to mean antlers, horns, tusks or any other bony protuberances from an animal's head. Antlers can be used for display in two basic configurations: a) separate antlers which are either sawed of the skull of the animal or shed naturally, b) a whole skull or partial skull with intact antlers. I will refer to this last configuration as a “one-piece skull-and-antler set”. The amount of partial skull varies from the whole skull less the jawbone to a thin band connecting the antlers. A common one-piece skull-and-antler set is formed when a taxidermist or other skilled individual cuts a generally circular piece from the top of a skull that has the antlers intact—the exact dimensions of the amount of skull vary.

Previously, the fabrication of antler mounts has been done in one of the following ways:

just antlers—removing antlers off of the skull of an animal and fastening them individually directly to a plaque;

bare one-piece skull-and-antler set—attaching a cleaned one-piece antlers-and-skull set directly or indirectly (for example with a brace, stand-off or neck) to a plaque;

separate antlers and bare skull—removing the antlers off of the skull of an animal and fastening them to a real or replica animal skull which is then mounted, uncovered, directly or indirectly on a plaque;

one-piece antler-and-skull-set and covered real skull—the one-piece antlers-and-skull set is optionally modified with structural materials, and covered with fabric, skin or some other covering that may simulate a life-like appearance, then fastened directly or indirectly to a plaque;

remove antlers, cover real or replica skull, replace antlers—the antlers are removed off of the skull of the animal, the real cleaned skull is optionally modified with structural materials, the skull is covered with fabric, skin or some other covering which may simulate a life-like appearance, then the antlers are re-attached to the covered skull which is then fastened directly or indirectly to a plaque; or

remove antlers, cover replica skull, attach antlers—the antlers are removed off of the animal skull, a replica skull is covered with fabric, skin or some other covering which may simulate a life-like appearance, then the antlers are attached to the covered replica skull, then the covered skull with antlers attached is fastened directly or indirectly to a plaque.

While some of these methods and resulting products are literally ancient, there are several modern methods that incorporate improvements to these traditional methods in the taxidermy art. Even still, there is the constant market need for a simpler, more efficient, cheaper solution to mounting antlers.

### SUMMARY

In one embodiment of the present invention, antlers are attached directly to a plaque. A replica skull, which contains a strategically located and shaped cutout, is then fitted over the mounted antlers and secured to the plaque also, removing the need to attach the antlers directly to the skull. A plaque, replica skulls in various sizes and animal species, and fittings can be sold in kits for the consumer to add his or her own antlers. Another embodiment is a new method by which the uniquely shaped replica skull and mount are fabricated.

### DRAWINGS

### Figures

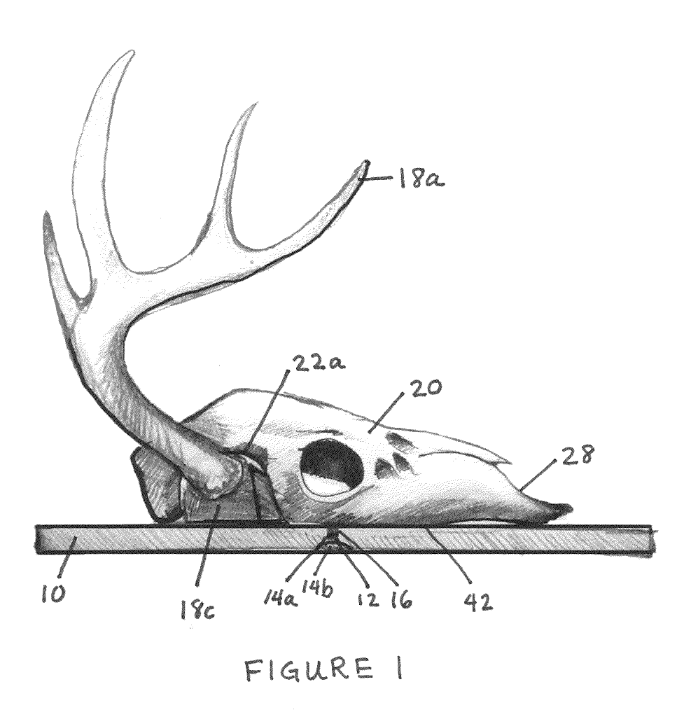

FIG. 1 shows a side view of one embodiment of an assembled improved mount

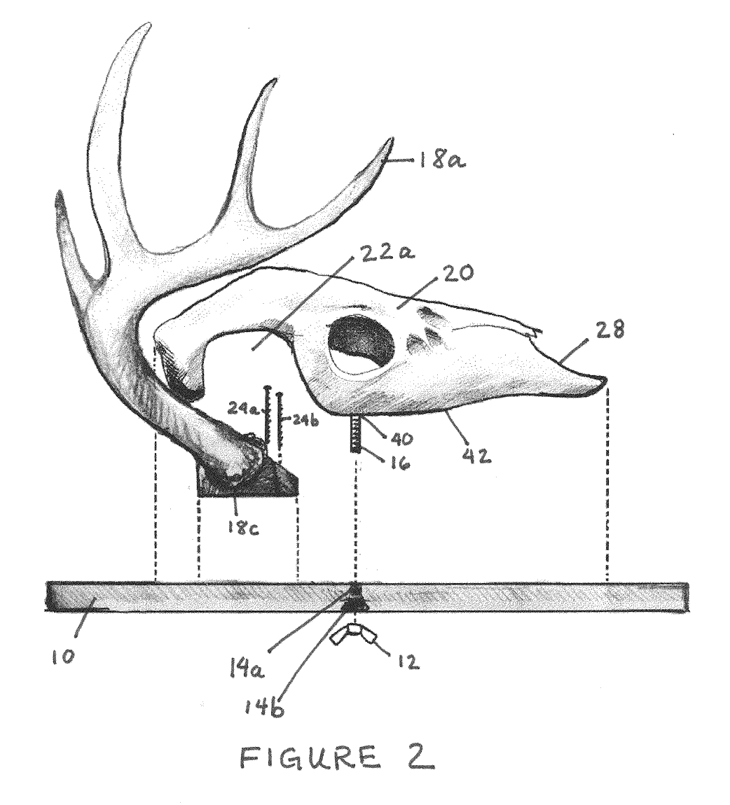

FIG. 2 shows an exploded, partially cut away, side view of one embodiment of an improved mount

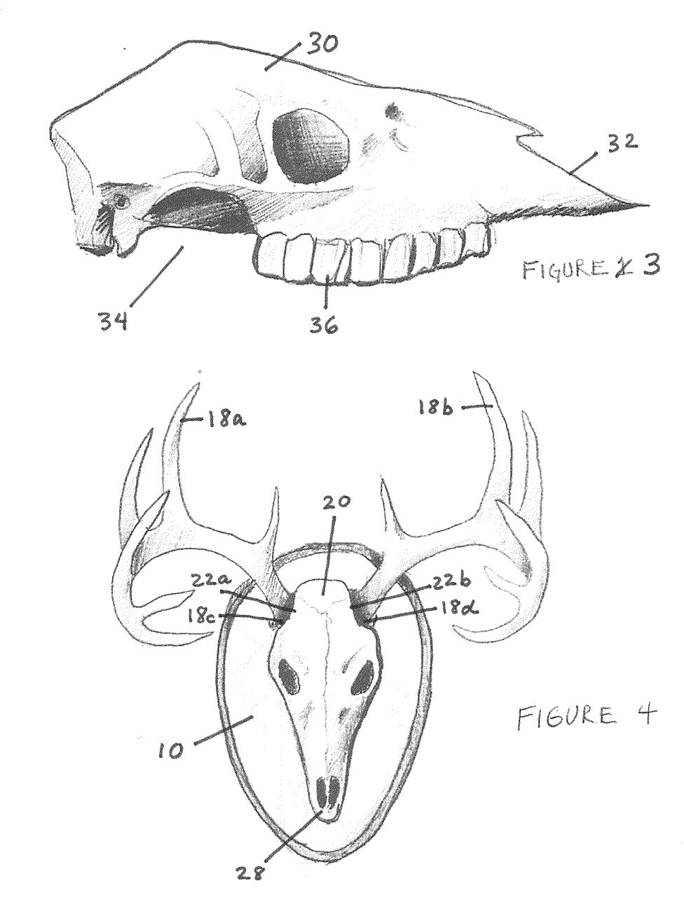

FIG. 3 shows a side view of a natural partial animal skull after the natural antlers have been removed and the area smoothed. This is illustrative of an early stage in the fabrication process of a replica skull in one embodiment of an improved mount.

FIG. 4 shows a front view of one embodiment of an assembled improved mount

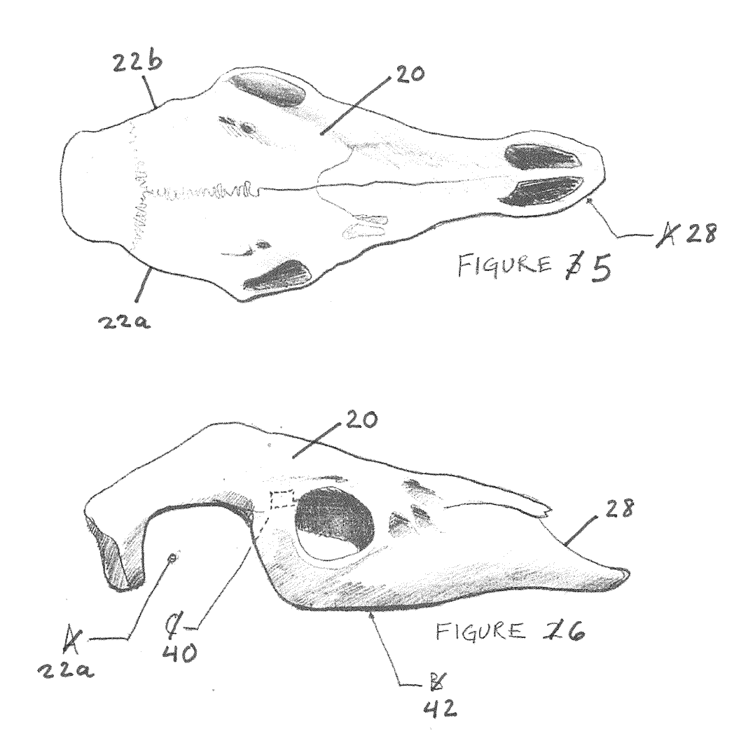

FIG. 5 shows a top view of one embodiment of a modified replica skull

FIG. 6 shows a side view of one embodiment of a modified replica skull

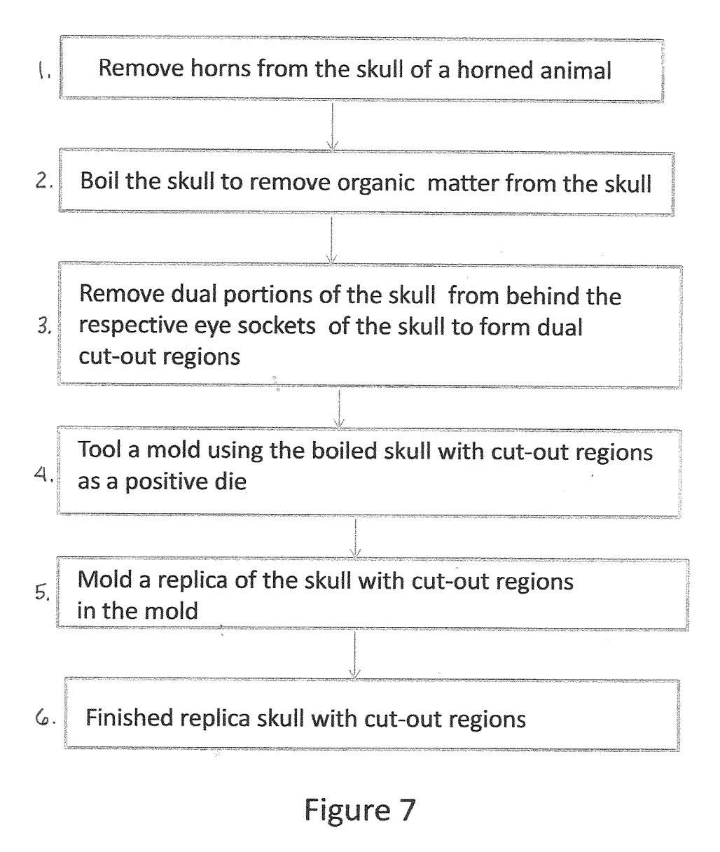

FIG. 7 shows one embodiment of a process for fabricating a modified replica skull

### DETAILED DESCRIPTION

### FIGS. 1 Through 6

### First Embodiment

One embodiment of the inventive mount is illustrated in FIG. 1. A plaque 10 or any potentially portable, substantially planar surface is adapted for use as a mount foundation. FIG. 1 shows plaque 10 lying horizontally to highlight the detail of other features but plaque 10 is intended to be hung or placed vertically. Plaque 10 may also have picture hanging hardware (not shown) or some other means by which it can be hung on a wall including, but not limited to: one or more hooks, nails, rings, rails, slots or holes. Plaque 10 can be made of any fairly rigid surface of any shape composed wholly or in part of materials including, but not limited to: wood, plastic, metal, leather, cardboard etc. The plaque 10 may also be adapted to fit into a rack or stand or have a hinged support leg to make it free-standing (not shown).

FIG. 1 also shows animal antlers 18a with an antler base 18c that is part of the natural antler. Antlers 18a can be natural or artificial and are fastened to plaque 10. Antler 18b and its corresponding base 18d are not shown in FIG. 1 but the placement is generally symmetrical, as it would be in nature—the placement can be more fully seen in FIG. 4. Antlers 18a and 18b may be separate from each other and if natural they may be shed antlers or sawed off a skull. Antlers 18a and 18b may also be two sides to a single antler piece with a whole skull or part of a skull joining them. The present embodiment may be used with either separate antlers or a whole or partial skull with antlers attached. The present embodiment may also be used with artificial antlers for decorative purposes.

FIG. 1 shows antlers 18a, which may or may not be connected to antlers 18b, resting on plaque 10 at base of antlers 18c. FIG. 2 shows the exploded view of FIG. 1 and shows antlers 18a connected to plaque 10 at base 18c by two screws 24a and 24b. Base 18c is the bottom part of the natural or artificial antler 18a and, similarly, base 18d (shown in FIG. 4) is the bottom part of the natural or artificial antler 18b (shown in FIG. 4). If shed or sawed off antlers are used, the base 18c may be slightly higher up on the antler 18a. Antlers 18a and 18b may be fastened to plaque 10 by any means, including, but not limited to: screws, nails, a bracket, a dowel and/or adhesives. FIG. 1 also shows how the antlers 18a and 18b do not come out of the replica skull at exactly the angle they do in nature (which would be straight out if the natural skull was flat against plaque 10) but at an angle modified for mount compactness, stability, and greater aesthetic appeal. Antler bases 18c and 18d and/or any skull portion that is attached between them (not shown) can be cut at any angle to maximize aesthetic appeal. Additionally wedge shaped matter (not shown) may be inserted as needed between antler base 18c and 18d and plaque 10 to adjust the angle of the antlers 18a and 18b to maximize aesthetic appeal.

FIG. 1 also shows that plaque 10 is attached to a modified replica skull 20 by (see partial cut-out on plaque 10 on FIG. 1) a bolt 16 which is attached to skull 20 and secured with a wing nut 12 which is connected through a straight hole 14a which opens into a conical hole 14b through plaque 10. Conical hole 14b may be rounded and is intended to conceal wing nut 12 so that the back of plaque 10 can be mounted flush to a wall. This configuration is shown clearly in FIG. 2, the exploded view. Any other connecting means may be used including but not limited to fastening the bolt to plaque 10 and attaching bolt receiving means such as a nut to the skull 20, or any number and configuration of bolts, nuts screws, dowels, adhesive, etc.

FIG. 1 also shows a modified replica skull 20. Modified replica skull 20 is a model of a natural animal scull which has certain modifications. The modifications can either be made to the natural skull before the replica skull is made or the modifications can be made to the already formed replica skull. Modified replica skull 20 includes a cavity 22a (left side). FIGS. 1, 2, and 6 show cavity 22a. FIG. 4 and FIG. 5 show the symmetrical cavity 22b on the opposite side of skull 20. The shape and placement of cavities 22a and 22b are approximately as shown but may differ slightly for different sized skulls and by the species of animal. Cavities 22a and 22b are shaped to fit over antlers 18a and 18b to maximize adjustability while minimizing gaps. Also visible in FIG. 1 is nose area 28 on skull 20 which may or may not be built up with putty material such as MAGIC SCULPT by WESCO of Sacramento, Calif. Also visible in FIG. 1 is modified tooth area 42 which is modified so that skull 20 will lie generally flat against plaque 10.

FIG. 2 shows an exploded view of FIG. 1. FIG. 2 shows, in one aspect of this embodiment, how antlers 18a attach to plaque 10 with two screws 24a and 24b at the antler base 18c. FIG. 2 shows, in one aspect of this embodiment, modified replica skull 20 with cavity 22a and built-in screw 16 which is attached to skull 20 at recess with bolt imbedding means 40 and modified tooth area 42 attach over antler 18a with bolt 16 which fits into straight hole 14a which is connected to conical hole 14b and fastened with wing nut 12. As previously discussed, antlers 18a and 18b can attach to plaque 10 by any means and modified replica skull can also attach to plaque 10 by any means. As shown in FIGS. 1, 2 and 4, the place where the base of antlers 18c and 18d are joined to plaque 10 is covered by modified replica skull 10 and hidden from view.

FIG. 3 shows a natural skull 30 with its natural antlers (not shown) sawed off and the area where they were sanded down and smoothed. FIG. 3 illustrates an early step in the fabrication method used to create a modified replica skull (reference 20 in FIGS. 1,2,4,5 and 6): FIG. 3 also shows an unmodified nose area 32, an unmodified cavity area 34, and an unmodified tooth area 36 for comparison to the modified replica skull (reference 20 in FIGS. 1,2,4,5 and 6).

FIG. 4 shows a front view of one aspect of this embodiment of an assembled mount. FIG. 4 shows the symmetrical placement of antler, left side, 18a and antler, right side, 18b onto plaque 10. FIG. 4 shows how, in this aspect of this embodiment, a modified replica skull 20 is fitted over the antler base, left side 18c and antler base, right side 18d and hides where antlers 18a and 18b are attached to plaque 10. As previously discussed, antler 18a and 18b can be connected to each other and affixed, in one piece, to plaque 10 with this connecting matter also hidden by replica skull 20. FIG. 4 also shows modified nose area 28. Skull 20 can be left bare or be covered by fabric, leather, beads or any other decoration (not shown) and can be modified with replica eyes (not shown) and/or fur (not shown) for a realistic look. Plaque 10 is shown in FIG. 4 as contoured but can take any shape. FIG. 4 shows the mounted antlers 18a and 18b and the mounted modified replica skull 20 centered on the plaque but these could be located in any configuration and other items can be mounted on plaque 10 also, including but not limited to dried or artificial foliage, a placard listing the animal's species, hunter and location of kill, or other antlers and skulls, for example.

FIG. 5 shows a top view of the modified replica skull 20. FIG. 5 shows how barely perceptible the cavities 22a and 22b are from the top view which enhances the value of modified replica skull 20 in hiding the connection points where antlers 18a and 18b are connected to plaque 10. FIG. 5 also shows a top view of modified nose area 28.

FIG. 6 shows a side view of the modified replica skull 20. FIG. 6 shows the approximate shape and location of cavity 22a. The shape and location would vary slightly by size of animal and species but would be approximately proportionate to cavity 22a as shown. Cavity 22b is not shown in FIG. 6 but is symmetrically located on the opposite side of modified replica skull 20. FIG. 6 also shows modified tooth area 42, modified nose area 28 and an optional recess with bolt imbedding means 40.

### Operation

### FIGS. 1-6

As to the manner of usage and operation of the aspects detailed above of the first embodiment of the improved trophy antler mount, the same should be apparent from the description above and no further discussion will be provided.

### Second Embodiment

### FIGS. 1, 2, and 4

FIG. 1 can also be used to illustrate another embodiment of the improved trophy mount. One aspect of Embodiment 2 is a kit of parts comprised of plaque 10 and modified replica skull 20 and one or more sets of attachment means. Sets of attachment means include attachment means between plaque 10 and modified replica skull 20, between plaque 10 and the wall or other surface and between plaque 10 and antlers 18a and 18b. Antlers 18a and 18b may optionally be included in the kit or be supplied by the kit user. FIG. 1 shows attachment means between plaque 10 and modified replica skull 20 of bolt 16 and wing nut 12. FIG. 2 shows this more clearly. FIG. 1 and FIG. 2 show a hole, optionally pre-drilled or marked, with a straight bore 14a and a conical bore 14b. Hole 14a/14b may have any bore shape or angle. In the aspect of embodiment 2 shown in FIGS. 1,2 and 4, the kit can include attachment means bolt 16 and wing nut 12 and hole 14a/14b may optionally be pre-drilled in plaque 10. Any attachment means for use between modified replica skull 20 and plaque 10 are possible and may be included in a kit.

FIG. 2 shows attachment means between antlers 18a and 18b and plaque 10 of two screws 24a and 24b. Any other attachment means for use between antlers 18a and 18b and plaque 10 are possible. In the aspect of embodiment 2 shown in FIGS. 1, 2 and 4, the kit can include attachment means screws 24a and 24b. Optionally holes can be pre-drilled or marked in plaque 10 to receive screws 24a and 24b.

In the aspect of embodiment 2 shown in FIGS. 1,2 and 4, the kit can include any attachment means to attach plaque 10 to a wall or other surface (not shown). FIG. 2 shows one possible aspect of the way the kit of embodiment 2 can be assembled. FIG. 4 shows one possible aspect of the way the kit of embodiment 2 appears when assembled. A template for where antlers 18a and 18b and antler bases 18c and 18d should be placed on plaque 10 relative to the particular replica of modified skull 20 that is included in the kit and/or other kit assembly instructions may be included in the kit.

### Operation

### FIGS. 1-6

As to the manner of usage and operation of the aspects detailed above of the second embodiment of the improved trophy antler mount, the same should be apparent from the description above and no further discussion will be provided.

### Third Embodiment

### FIGS. 1,3,5,6, and 7

FIG. 7 illustrates a method of manufacture that can be used to manufacture components of embodiments 1 and 2. FIGS. 1, 3, 5 and 6 show aspects of components discussed in the operation of the method.

### Operation

### FIGS. 1,3,5,6, and 7

One aspect of embodiment 3 contains the following primary steps:
1) remove antlers from the skull of a antlered animal, 2) boil the skull to remove organic matter from the skull, 3) remove dual portions of the skull from behind the respective eye sockets of the skull to form dual cut-out regions (cavities), 4) tool a mold using the boiled skull with the cut-out regions as a positive die, 5) mold a replica of the skull with the cut-out regions (cavities) in the mold, and the result is 6) a finished replica skull with cut-out regions.
These steps will be discussed in detail:

Step 1) is to remove antlers from the skull of a antlered animal. The antlers are sawed off flush with the skull and the site is sanded smooth. FIG. 3 illustrates what this looks like.

Step 2) is to boil the skull to remove organic matter from the skull.

Step 3) is to modify the cleaned skull so that it can be used to make a mold. Portions of the skull are cut out from behind the respective eye sockets to form dual cut-out regions. The shape and placement of the cut-outs (cavities) are substantially as shown in FIG. 6, ref num 22a. FIG. 6 shows the replica skull that is a result of one aspect of this process. The shape and location may vary slightly by size of animal and species replicated but would be approximately proportionate to cavity 22a as shown. Cavity 22b is not shown in FIG. 6 but is symmetrically located on the opposite side of modified replica skull 20.

Another modification to the cleaned skull shown in FIG. 3, ref num 30 is the sawing off of the skull in the tooth area (FIG. 6, ref num 42) so that the skull will sit substantially flush to a flat surface. This is shown in FIG. 1, ref num 42. Only enough skull is cut away to remove the teeth and the roots. A putty material to include but not limited to MAGIC SCULPT made by WESCO of Sacramento, CA, is used to smooth out and fill in any voids. Putty material is also used to modify nose area (FIG. 3, ref num 32) into modified nose area (FIG. 5 ref num 28). Putty material is also used, as needed, to fill in the underside of the cleaned skull (not shown), the nasal passages (not shown), in front of the eyes (not shown) and any other places needed to improve aesthetic appearance (not shown). An optional recess with bolt imbedding means (FIG. 6, ref num 40) is carved in the bottom of the putty.

Step 4) is to create a mold using the modified boiled skull. One aspect of embodiment 3 is to create a two-part casting system to make the modified replica skull (FIG. 6, ref num 20). Modified replica skull 20 can be made of any maliable substance including but not limited to plastic, clay, metal, or rubber and any molding system can be used. One system that can be used is POR-A-KAST made by PUMA Polymers LLC of Chattanooga, Tenn. (formerly a division of Pathway Polymers, bought by management in 2009).

Step 5) is to mold a replica of the modified boiled skull. Using the molding system of step 4, above, the modified boiled skull is used as a positive die and a two piece rubber mold is made. In this system a plastic material is then poured in the mold and many replicas can be produced from the same mold.

Step 6) is the termination of the process—the modified replica skull is finished.

I claim:

1. A taxidermy method comprising:
removing horns from a skull of a horned animal;
boiling the skull to remove organic matter from the skull;
removing dual portions of the skull from behind the respective eye sockets of the skull to form dual cut-out regions;
tooling a mold using the boiled skull with cut-out regions as a positive die; and
making a replica of the skull with cut-out regions in the mold.

2. The method of claim 1, further comprising sanding non-smooth surfaces of the skull before tooling the mold.

3. The method of claim 1, further comprising filling cavities in the skull with a filler before tooling the mold.

4. The method of claim 1, further comprising affixing horns of a different horned animal and the molded replica to a portable substantially planar surface.
